(19) United States
(12) Patent Application Publication
(10) Pub. No.: US 2014/0074814 A1
(43) Pub. Date: Mar. 13, 2014

(54) METHOD AND APPARATUS FOR SWITCHING SEARCH ENGINE TO REPEAT SEARCH

(71) Applicant: TENCENT TECHNOLOGY (SHENZHEN) COMPANY LIMITED, Shenzhen (CN)

(72) Inventors: JUN YE, Shenzhen (CN); FANG HUANG, Shenzhen (CN)

(73) Assignee: TENCENT TECHNOLOGY (SHENZHEN) COMPANY LIMITED, Shenzhen (CN)

(21) Appl. No.: 14/077,336

(22) Filed: Nov. 12, 2013

Related U.S. Application Data
(63) Continuation of application No. PCT/CN2013/082153, filed on Aug. 23, 2013.

(30) Foreign Application Priority Data
Aug. 24, 2012 (CN) 201210305546.9

(51) Int. Cl. G06F 17/30

(52) U.S. Cl. CPC G06F 17/30864
USPC 707/707

(57) ABSTRACT

A method is provided for switching search engine to repeat search are provided herein. The method includes generating a fixed search wrapper in a page or a window pre-determined by a browser, and the page or the window can be nested within the search wrapper. Further, the method includes displaying the search wrapper in a search results page of a first search engine when a user selects the first search engine listed in the browser to perform a search, and other search engine options can be displayed in the search wrapper. Still further, the method includes repeating the search using current search keywords through a second search engine selected by the user from the other search engine options, when the user requests to switch to the selected second search engine to repeat the search.

### CROSS-REFERENCES TO RELATED APPLICATIONS

This application is a continuation of PCT Patent Application No. PCT/CN2013/082153, filed on Aug. 23, 2013, which claims priority to Chinese Patent Application No. 201210305546.9, filed on Aug. 24, 2012, the entire contents of all of which are incorporated herein by reference.

### FIELD OF THE INVENTION

The present disclosure generally relates to Internet technology and, more particularly, relates to methods and apparatus for switching search engine to repeat search.

### BACKGROUND

In browser technology, uniform/universal resource locators (URLs) of some search engines are often pre-embedded in search boxes. A search can be accomplished by search engine hyperlink jumping. For example, a search URL of Soso webpage is: http://wap.soso.com/sweb/search.jsp?st=input&amp;g_f=882&amp;so_g_f=882&amp;key=. After a user inputs keywords in a search box on the Soso webpage, the search engine of Soso webpage fills in the keywords following the equal sign “=”, transmits the keywords to a search engine server, and jumps to a search results page.

However, in existing browser search technology, when searching using a search box in a browser, if a user is not satisfied with the search results, the user cannot rapidly switch to another search engine to repeat the search. Instead, the user needs to enter a search page of another search engine and re-enter the keywords to search.

### BRIEF SUMMARY OF THE DISCLOSURE

One aspect of the present disclosure includes a method for switching search engine to repeat search. The method includes generating a fixed search wrapper in a page or a window pre-determined by a browser, and the page or the window is nested within the search wrapper. Further, the method includes displaying the search wrapper in a search results page of a first search engine when a user selects the first search engine listed in the browser to perform a search, and other search engine options are displayed in the search wrapper. Still further, the method includes repeating the search using current search keywords through a second search engine selected by the user from the other search engine options, when the user requests to switch to the selected second search engine to repeat the search.

Another aspect of the present disclosure includes an apparatus for switching search engine to repeat search. The apparatus includes a generation module, a display module, and a repeat-search module. The generation module is configured to generate a fixed search wrapper in a page or window pre-determined by a browser, and the page or the window is nested within the search wrapper. The display module is configured to display the search wrapper in a search results page of a first search engine when a user selects the first search engine listed in the browser to perform a search, and to display other search engine options in the search wrapper. The repeat-search module is configured to repeat the search using current search keywords through a second search engine selected by the user from the other search engine options, when the user requests to switch to the selected second search engine to repeat the search.

Another aspect of the present disclosure includes non-transitory computer-readable medium containing executable computer program, which, when being executed by a processor, performs a method for switching search engine to repeat search. The method includes generating a fixed search wrapper in a page or a window pre-determined by a browser, and the page or the window is nested within the search wrapper. Further, the method includes displaying the search wrapper in a search results page of a first search engine when a user selects the first search engine listed in the browser to perform a search, and other search engine options are displayed in the search wrapper. Still further, the method includes repeating the search using current search keywords through a second search engine selected by the user from the other search engine options, when the user requests to switch to the selected second search engine to repeat the search.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts a flow diagram of an exemplary method for switching search engine to repeat search in accordance with various disclosed embodiments;

FIG. 2 depicts generation of a search wrapper in a webpage or window specified by a browser, in an exemplary method for switching search engine to repeat search in accordance with various disclosed embodiments;

FIG. 3 depicts generation of a search header in a search results page obtained by a user's webpage search, in an exemplary method for switching search engine to repeat search in accordance with various disclosed embodiments;

FIG. 4 depicts a flow diagram of repeating search in an exemplary method for switching search engine to repeat search in accordance with various disclosed embodiments;

FIG. 5 depicts a structure diagram of an exemplary apparatus for switching search engine to repeat search in accordance with various disclosed embodiments;

FIG. 6 depicts a structure diagram of a repeat-search module of an exemplary apparatus for switching search engine to repeat search in accordance with various disclosed embodiments;

FIG. 7 depicts an exemplary environment incorporating certain disclosed embodiments; and

FIG. 8 depicts an exemplary server consistent with the disclosed embodiments.

### DETAILED DESCRIPTION

Reference will now be made in detail to exemplary embodiments of the invention, which are illustrated in the accompanying drawings.

Various disclosed embodiments provide methods and apparatus for switching search engine to repeat search. A fixed search wrapper can be generated in a page or a window pre-determined by a browser. When a user selects a first search engine of the browser to perform a search, the search wrapper can be displayed in a search results page of the first search engine. Other search engine options for searching can be displayed in the search wrapper. If the user is not satisfied with search results and needs to switch search engine to repeat the search, a second search engine selected by the user from the other search engine options can be used to repeat the search using current search keywords. Thus, rapid switching between search engines can be realized, and users' webpage search efficiency can be improved.

As used herein, unless otherwise specified, the term “search engine” in this disclosure may also be referred to as “engine”. The term “webpage” in this disclosure may also be referred to as “page”. The term “search keywords” in this disclosure may also be referred to as “keywords”.

As used herein, a wrapper in this disclosure may refer to a structure or frame generated by a browser. A wrapper can be displayed within a browser window (or a window). Alternatively, a window can be nested within a wrapper. When a webpage is displayed in the browser window, the contents of the webpage can be nested within the wrapper. A wrapper can provide certain functions to users. Software/program may be embedded in a wrapper, and corresponding contents may be displayed in the display area of the wrapper. Accordingly, a user may input information within the display area of the wrapper, such as entering contents and/or making selections among various displayed options, to prompt certain actions by the browser. A wrapper may be formed by using software codes or by any other suitable methods.

As used herein, a search wrapper in this disclosure may refer to a wrapper that is displayed in a browser window during search operations.

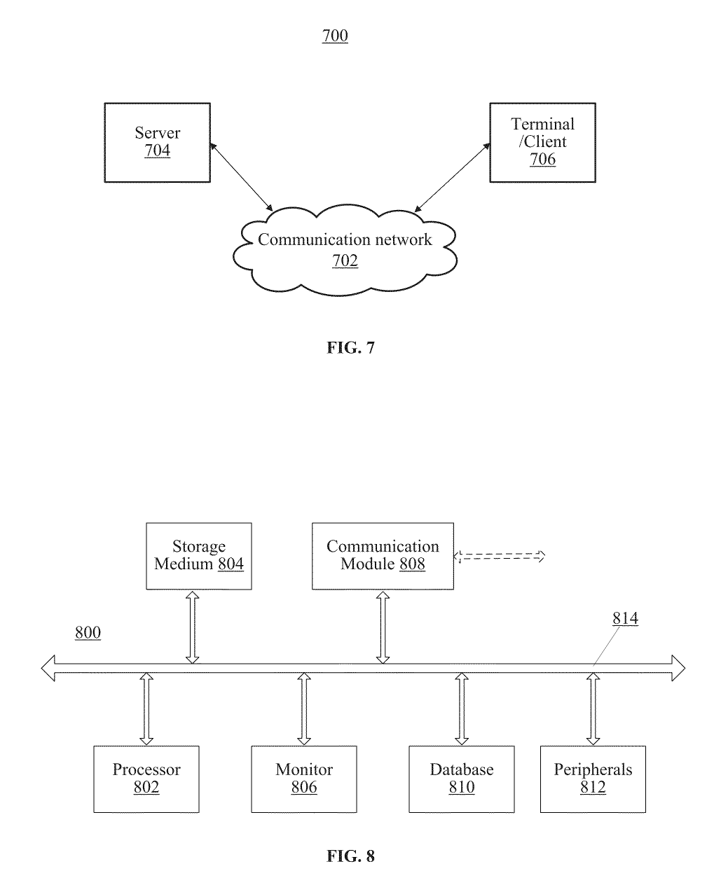

FIG. 7 depicts an exemplary environment incorporating exemplary methods and apparatus for switching search engine to repeat search in accordance with various disclosed embodiments. As shown in FIG. 7, the environment 700 can include a server 704, a terminal 706, and a communication network 702. The server 704 and the terminal 706 may be coupled through the communication network 702 for information exchange, such as Internet searching, webpage browsing, etc. Although only one terminal 706 and one server 704 are shown in the environment 700, any number of terminals 706 or servers 704 may be included, and other devices may also be included.

The communication network 702 may include any appropriate type of communication network for providing network connections to the server 704 and terminal 706 or among multiple servers 704 or terminals 706. For example, the communication network 702 may include the Internet or other types of computer networks or telecommunication networks, either wired or wireless.

A terminal, as used herein, may refer to any appropriate user terminal with certain computing capabilities including, e.g., providing a browser for webpage browsing and for receiving information (such as keywords) inputted by a user for web searching. For example, a terminal can be a personal computer (PC), a work station computer, a server computer, a hand-held computing device (tablet), a mobile terminal (a mobile phone or a smart phone), or any other user-side computing device.

A server, as used herein, may refer to one or more server computers configured to provide certain server functionalities, such as searching the web. As in various embodiments disclosed herein, a search engine server can perform webpage searches using keywords transmitted by a search engine. A server may also include one or more processors to execute computer programs in parallel.

The server 704 and the terminal 706 may be implemented on any appropriate computing platform. FIG. 8 shows a block diagram of an exemplary computing system 800 capable of implementing the server 704 and/or the terminal 706. As shown in FIG. 8, the exemplary computer system 800 may include a processor 802, a storage medium 804, a monitor 806, a communication module 808, a database 810, peripherals 812, and one or more bus 814 to couple the devices together. Certain devices may be omitted and other devices may be included.

The processor 802 can include any appropriate processor or processors. Further, the processor 802 can include multiple cores for multi-thread or parallel processing. The storage medium 804 may include memory modules, such as ROM, RAM, and flash memory modules, and mass storages, such as CD-ROM, U-disk, removable hard disk, etc. The storage medium 804 may store computer programs for implementing various processes, when executed by the processor 802.

The monitor 806 may include display devices for displaying information. For example, the monitor 806 of the terminal 706 can be used by a user to display browser window and webpage contents, etc. The communication module 808 may include network devices for establishing connections through the communication network 702. The database 810 may include one or more databases for storing certain data and for performing certain operations on the stored data. For example, the database 810 of the server 704 can be used to perform data operations for webpage browsing, webpage searching, etc.

Further, the peripherals 812 may include I/O devices such as keyboard and mouse. For example, the peripherals 812 of the terminal 706 can be used by a user to input keywords for webpage searching, and/or to click certain option buttons in a browser window.

In operation, the terminal 706 may cause the server 704 to perform certain actions, such as an Internet search or other database operations. The server 704 may be configured to provide structures and functions for such actions and operations. More particularly, the server 704 may be a search engine system for webpage searching.

In various embodiments, a terminal such as a user-side electronic device involved in the disclosed methods and systems can include the terminal 706, while a search engine server involved in the disclosed methods and systems can include the server 704.

Unless otherwise specified, the disclosed methods and apparatus can be executed by a user-side electronic device, such as a personal computer (PC), a work station computer, a hand-held computing device (tablet), a mobile terminal (a mobile phone or a smart phone), or any other user-side computing device. As used herein, unless otherwise specified, the term “user-side electronic device” in this disclosure may be referred to as “electronic device”.

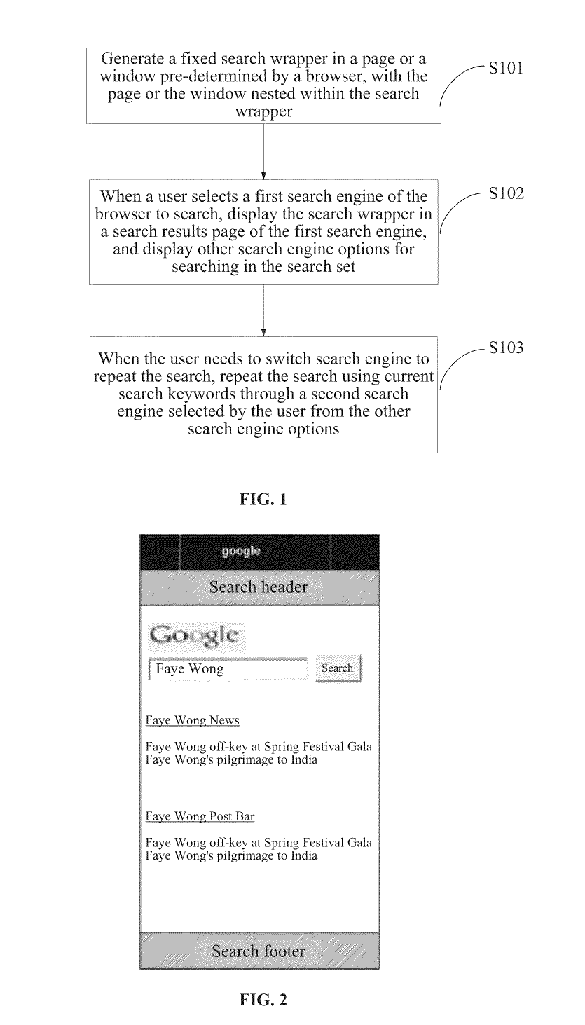

FIG. 1 depicts a flow diagram of an exemplary method for switching search engine to repeat search in accordance with various disclosed embodiments.

In Step S101, a fixed search wrapper is generated in a page or a window pre-determined by a browser. The page or the window can be nested within the search wrapper.

In an installation package of the browser, the fixed search wrapper can be generated in the specified page or window. For example, FIG. 2 depicts generation of a fixed search wrapper in a webpage or window specified by a browser, in an exemplary method for switching search engine to repeat search in accordance with various disclosed embodiments.

As shown in FIG. 2, the search wrapper can be set at the top of the page or the window pre-determined by the browser, and the search wrapper can thus be referred to as a header, a search header, a header-wrapper, or a search header-wrapper. Or, the search wrapper can be set at the bottom of the page or the window pre-determined by the browser, and the search wrapper can thus be referred to as a footer, a search footer, a footer-wrapper or a search footer-wrapper. An original webpage or a window can be nested within the search wrapper. In one embodiment, a webpage can be nested between the header and the footer.

Specifically, if a header and/or a footer is generated in a specified page, the page may need to be identified according to a domain name of the page. When a URL or domain name of an opened page (such as a page for webpage search) is the same as a specified URL or domain name, the header and/or the footer can be generated in the page.

Take Soso search as an example. When the domain name of a webpage in the window of the browser is http://wap.soso.com/sweb/search.jsp?st=input&amp;g_f=882&amp;so_g_f=882&amp;key=, and is the same as a specified domain name, the header and/or the footer can then be generated in the webpage window.

If a header and/or a footer is generated in a specified window, the header and/or the footer can appear in a page in the specified window according to a specific number of opened windows or a source of the window. In one embodiment, a header can appear in a window opened through the search box window. In another embodiment, a header can appear in a second or a third window opened through a search box window.

In Step S102, when a user selects a first search engine of the browser to perform a search, the search wrapper is displayed in a search results page of the first search engine. Other search engine options for searching can be displayed in the search wrapper.

When the user needs to search webpage, the user can input keywords in a search box of a first search engine of the browser. For example, a first search engine of the browser can be a search engine that is listed in the browser. The page of the current search engine can be a specified page pre-determined by the browser, so the fixed search wrapper can be generated as depicted in various disclosed embodiments, e.g., as in Step S101. The first search engine can transmit the keywords through a link to a corresponding search engine server for searching. First search results can be obtained in a first search results page.

As used herein, unless otherwise specified, the term “first search results” in this disclosure can be referred to as ‘search results”, and the term “first search results page” in this disclosure can be referred to as ‘search results page”.

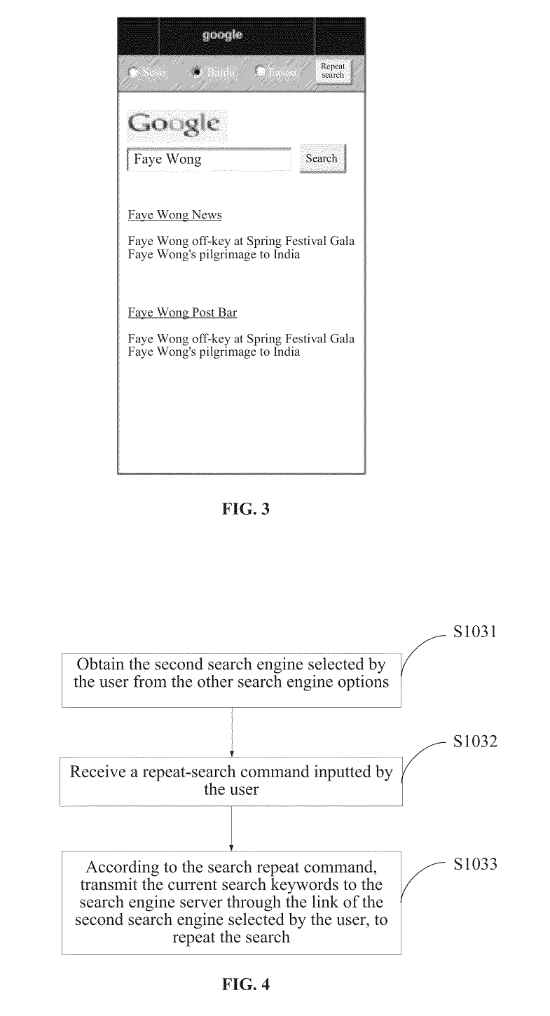

For example, a search header can be generated in the first search results page. FIG. 3 depicts generation of a search header in a search results page obtained by a user's webpage search, in an exemplary method for switching search engine to repeat search in accordance with various disclosed embodiments. As shown in FIG. 3, the user can perform a search in a search box of Google search engine using “Faye Wong” (a Chinese singer's name) as search keywords. A first search results page by the Google search engine about Faye Wong can be obtained. A search header can be generated in the first search results page.

At the same time, other search engine options for searching, except the current search engine, can be displayed in the search header, such as Soso, Baidu, Easou, etc., as shown in FIG. 3. In addition, a repeat-search button option, also referred to as a “repeat-search button”, can be set in the search header. Thus, in subsequent steps, according to specific needs, the user can select a corresponding search engine from the other search engine options for searching, and click the repeat-search button to repeat the search.

The browser can record the search keywords and the search engine of the first search results page. In one embodiment, the search keywords and the search engine of the first search results page can be recorded through transmission records of the browser's search results. In another embodiment, the search keywords and the search engine of the first search results page can be confirmed (i.e., recorded) through analyzing root domain name of the window, e.g., “wap.soso.com”, and through parsing page for the built-in keywords in the search box.

As disclosed herein, the search keywords and the search engine of the first search results page can be recorded. Thus, other search engine options for searching, except the current search engine, can be properly displayed in the search header. In addition, in subsequent steps, the users can repeat the search without re-entering the keywords.

In Step S103, when the user needs to switch search engine to repeat the search, the search is repeated using the current search keywords through the search engine selected by the user from the other search engine options for searching.

As used herein, “switching search engine” in this disclosure refers to switching from one search engine to another search engine. For example, “switching search engine” can include switching from a current search engine to a search engine selected from other search engine options.

When the user is not satisfied with the first search results, the user can select a separate search engine (that is, a second search engine) from the other search engine options in the first search results page, and click the repeat-search button to repeat the search. When the user clicks the repeat-search button, the browser can transmit the keywords of the current page to a search engine server of the selected search engine (i.e., the second search engine) for searching. The transmission of the keywords can be accomplished through a link of the selected second search engine in the search header.

Specifically, for example, FIG. 4 depicts a flow diagram of repeating search in an exemplary method for switching search engine to repeat search in accordance with various disclosed embodiments. As shown in FIG. 4, describing more details corresponding to Step S103 in FIG. 1, the repeating of the search using the current search keywords through the search engine selected by the user from the other search engine options can include Steps S1031-S1033 as follows.

In Step S1031, the second search engine selected by the user from the other search engine options for searching is obtained.

In Step S1032, a repeat-search command inputted by the user is received.

In Step S1033, according to the repeat-search command, the current search keywords are transmitted to the search engine server of the selected second search engine to repeat the search. The transmission of the keywords can be accomplished through a link of the selected second search engine in the search header.

According to various disclosed embodiments, the fixed search wrapper can be generated in the page or window pre-determined by the browser. When the user selects a search engine of the browser (i.e., a first search engine) to perform a search, the search wrapper can be displayed in the search results page of the search engine. Other search engine options for search can be displayed in the search wrapper. If the user is not satisfied with search results and needs to switch search engine to repeat the search, the search can be repeated using current search keywords through a search engine selected by the user from the other search engine options (i.e., a second search engine). Thus, rapid switching between search engines can be realized, and users' webpage search efficiency can be improved.

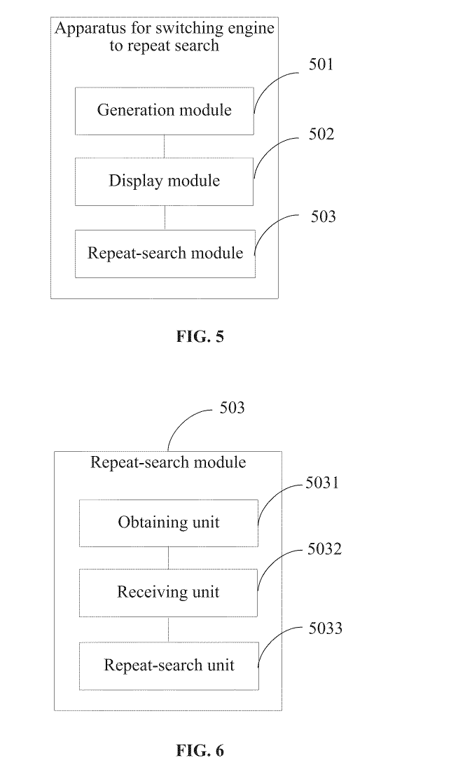

FIG. 5 depicts a structure diagram of an exemplary apparatus for switching search engine to repeat search in accordance with various disclosed embodiments. As shown in FIG. 5, an exemplary apparatus for switching search engine to repeat search can include a generation module 501, a display module 502, and a repeat-search module 503. Other modules may also be included.

The generation module 501 is configured to generate a fixed search wrapper in a page or a window pre-determined by a browser. The page or the window can be nested within the search wrapper.

The display module 502 is configured to display the search wrapper in a search results page of a first search engine when a user selects the search engine of the browser to perform a search, and to display other search engine options for searching in the search wrapper.

The repeat-search search module 503 is configured to repeat the search using current search keywords through a second search engine selected by the user from the other search engine options for search, when the users needs to switch search engine to repeat the search.

In an installation package of the browser, the fixed search wrapper can be generated in a specified page or window. Referring to FIG. 2, the search wrapper can be set at the top of the page or the window pre-determined by the browser, and the search wrapper can thus be referred to as a header, a search header, a header-wrapper, or a search header-wrapper. Or, the search wrapper can be set at the bottom of the page or the window pre-determined by the browser, and the search wrapper can thus be referred to as a footer, a search footer, a footer-wrapper or a search footer-wrapper. An original webpage or a window can be nested within the search wrapper. In one embodiment, a webpage can be nested between the header and the footer.

Specifically, if a header and/or a footer is generated in a specified page, the page may need to be identified according to a domain name of the page. When a URL or domain name of an opened page (such as a page for webpage search) is the same as a specified URL or domain name, the header and/or the footer can be generated in the page.

Take Soso search as an example. When the domain name of a webpage in the window of the browser is http://wap.soso.com/sweb/search.jsp?St=input&amp;g_f=882&amp;so_g_f=882&amp;key=, and is the same as a specified domain name, the header and/or the footer can then be generated in the webpage window.

If a header and/or a footer is generated in a specified window, the header and/or the footer can appear in a page in the specified window according to a specific number of opened windows or a source of the window. In one embodiment, a header can appear in a window opened through the search box window. In another embodiment, a header can appear in a second or a third window opened through a search box window.

When the user needs to search webpage, the user can input keywords in a search box of a first search engine of the browser. For example, a first search engine of the browser can be a search engine that is listed in the browser. The page of the current search engine can be a specified page pre-determined by the browser, so the fixed search wrapper can be generated as depicted in various disclosed embodiments, e.g., by the generation module 501. The search engine can transmit the keywords through a link to a search engine server for searching. First search results can be obtained in a first search results page.

For example, a search header can be generated in the first search results page. As shown in FIG. 3, the user can perform a search in a search box of Google search engine using “Faye Wong” as search keywords. A first search results page by the Google search engine about Faye Wong can be obtained. A search header can be generated in the first search results page. At the same time, other search engine options for searching, except the current search engine (i.e., the first search engine), can be displayed in the search header, such as Soso, Baidu, Easou, etc., as shown in FIG. 3. In addition, a repeat-search button option, also referred to as a “repeat-search button”, can be set in the search header. Thus, in subsequent steps, according to specific needs, the user can select a separate search engine (i.e., a second search engine) from the other search engine options for searching, and click the repeat-search button to repeat the search.

The browser can record the search keywords and the search engine of every search results page. Thus, the browser can record the search keywords and the search engine of the first search results page. In one embodiment, the search keywords and the search engine of the first search results page can be recorded through transmission records of the browser's search results. In another embodiment, the search keywords and the search engine of the first search results page can be confirmed (i.e., recorded) through analyzing root domain name of the window, e.g., “wap.soso.com”, and through parsing page for the built-in keywords in the search box.

When the user is not satisfied with the first search results, the user can select a separate search engine (i.e., a second search engine) from the other search engine options in the first search results page, and click the repeat-search button to repeat the search. When the user clicks the repeat-search button, the browser can transmit the keywords of the current page to a search engine server of the selected search engine for searching. The transmission of the keywords can be accomplished through a link of the selected search engine in the search header.

Specifically, for example, FIG. 6 depicts a structure diagram of a repeat-search module of an exemplary apparatus for switching search engine to repeat search in accordance with various disclosed embodiments. As shown in FIG. 6, the repeat-search module 503 can include an obtaining unit 5031, a receiving unit 5032 and a repeat-search unit 5033.

The obtaining unit 5031 is configured to obtain the search engine selected by the user (i.e., the second search engine) from the other search engine options for searching. The receiving unit 5032 is configured to receive a repeat-search command inputted by the user.

The repeat-search unit 5033 is configured to transmit the current search keywords to the search engine server of the selected second search engine to repeat the search according to the repeat-search command. The transmission of the keywords can be accomplished through a link of the selected second search engine in the search header.

As disclosed herein, various embodiments provide methods and apparatus for switching search engine to repeat search. A fixed search wrapper can be generated in a page or a window pre-determined by a browser. When a user selects a search engine of the browser (i.e., a first search engine) to perform a search, the search wrapper can be displayed in a search results page of the search engine. Other search engine options for searching can be displayed in the search wrapper. If the user is not satisfied with search results and needs to switch search engine to repeat the search, the search can be repeated using current search keywords through a search engine selected by the user from the other search engine options (i.e., a second search engine). Thus, rapid switching between search engines can be realized, and users' webpage search efficiency can be improved.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

The disclosed methods and apparatus can be used in a variety of Internet applications. By using the disclosed methods and apparatus, a fixed search wrapper can be generated in a page or a window pre-determined by a browser. When a user selects a first search engine listed in the browser to perform a search, the search wrapper can be displayed in a search results page of the first search engine. Other search engine options are displayed in the search wrapper. Thus, the user can select a second search engine from the other search engine options. When the user requests to switch to the selected second search engine to repeat the search, the search can be repeated using current search keywords through the selected second search engine. Therefore, to repeat the search, the user does not need to enter a search page of the selected search engine and re-enter the keywords. Thus, rapid switching between search engines can be realized, and users' webpage search efficiency can be improved.

What is claimed is:

1. A method for switching search engine to repeat search, comprising:
generating a fixed search wrapper in a page or a window pre-determined by a browser, wherein the page or the window is nested within the search wrapper;
displaying the search wrapper in a search results page of a first search engine when a user selects the first search engine listed in the browser to perform a search, wherein other search engine options are displayed in the search wrapper; and
repeating the search using current search keywords through a second search engine selected by the user from the other search engine options, when the user requests to switch to the selected second search engine to repeat the search.

2. The method according to claim 1, wherein the generating of the fixed search wrapper in the page pre-determined by the browser includes:
obtaining a domain name or a uniform resource locator (URL) of a page that is opened; and
generating the fixed search wrapper in the page when the domain name or the URL of the page is the same as a specified domain name or a specified URL.

3. The method according to claim 1, wherein the generating of the fixed search wrapper in the window pre-determined by the browser includes:
generating the fixed search wrapper in the window according to a number of opened windows or a source of the window.

4. The method according to claim 1, wherein the repeating of the search using the current search keywords through the second search engine selected by the user from the other search engine options includes:
obtaining the second search engine selected by the user from the other search engine options;
receiving a repeat-search command inputted by the user; and
transmitting the current search keywords through a link of the second search engine selected by the user, to a search engine server to repeat the search, according to the repeat-search command.

5. The method according to claim 1, wherein the search wrapper is at least one of a header at a top of the page or the window pre-determined by the browser and a footer at a bottom of the page or the window pre-determined by the browser.

6. An apparatus for switching search engine to repeat search, comprising:
a generation module, configured to generate a fixed search wrapper in a page or window pre-determined by a browser, wherein the page or the window is nested within the search wrapper;
a display module, configured to display the search wrapper in a search results page of a first search engine when a user selects the first search engine listed in the browser to perform a search, and to display other search engine options in the search wrapper; and
a repeat-search module, configured to repeat the search using current search keywords through a second search engine selected by the user from the other search engine options, when the user requests to switch to the selected second search engine to repeat the search.

7. The apparatus according to claim 6, wherein the generation module is further configured to:
obtain a domain name or a URL of a page that is opened; and
generate the fixed search wrapper in the page when the domain name or the URL of the page is the same as a specified domain name or a specified URL.

8. The apparatus according to claim 6, wherein the generation module is further configured to:
generate the fixed search wrapper in the window according to a number of opened windows or a source of the window.

9. The apparatus according to claim 6, wherein the repeat-search module includes:
an obtaining unit, configured to obtain the second search engine selected by the user from the other search engine options;
a receiving unit, configured to receive a repeat-search command inputted by the user; and
a repeat-search unit, configured to transmit the current search keywords through a link of the second search engine selected by the user, to a search engine server to repeat the search, according to the repeat-search command.

10. The apparatus according to claim 6, wherein the search wrapper is at least one of a header at a top of the page or the window pre-determined by the browser and a footer at a bottom of the page or the window pre-determined by the browser.

11. A non-transitory computer-readable medium containing executable computer program for, when being executed by a processor, performing a method for switching search engine to repeat search, the method comprising:
generating a fixed search wrapper in a page or a window pre-determined by a browser, wherein the page or the window is nested within the search wrapper;
displaying the search wrapper in a search results page of a first search engine when a user selects the first search engine listed in the browser to perform a search, wherein other search engine options are displayed in the search wrapper; and
repeating the search using current search keywords through a second search engine selected by the user from the other search engine options, when the user requests to switch to the selected second search engine to repeat the search.

12. The computer-readable medium according to claim 11, wherein the generating of the fixed search wrapper in the page pre-determined by the browser includes:
obtaining a domain name or a uniform resource locator (URL) of a page that is opened; and
generating the fixed search wrapper in the page when the domain name or the URL of the page is the same as a specified domain name or a specified URL.

13. The computer-readable medium according to claim 11, wherein the generating of the fixed search wrapper in the window pre-determined by the browser includes:
generating the fixed search wrapper in the window according to a number of opened windows or a source of the window.

14. The computer-readable medium according to claim 11, wherein the repeating of the search using the current search keywords through the second search engine selected by the user from the other search engine options includes:
obtaining the second search engine selected by the user from the other search engine options;
receiving a repeat-search command inputted by the user; and
transmitting the current search keywords through a link of the second search engine selected by the user, to a search engine server to repeat the search, according to the repeat-search command.

15. The computer-readable medium according to claim 11, wherein the search wrapper is at least one of a header at a top of the page or the window pre-determined by the browser and a footer at a bottom of the page or the window pre-determined by the browser.
